(19) United States
(12) Patent Application Publication
(10) Pub. No.: US 2015/0303760 A1
(43) Pub. Date: Oct. 22, 2015

(54) GEARLESS DRIVE FOR A ROTATING ELECTRICAL MACHINE

(71) Applicant: GE Energy Power Conversion Technology Ltd, Rugby, Warwickshire (GB)

(72) Inventor: Stuart Ian Bradley, Leicestershire (GB)

(73) Assignee: GE Energy Power Conversion Technology Ltd, Rugby, Warwickshire (GB)

(21) Appl. No.: 14/375,926

(22) PCT Filed: Jan. 31, 2013
(86) PCT No.: PCT/EP13/51876

§ 371 Date: Jul. 31, 2014

(30) Foreign Application Priority Data
Feb. 1, 2012 (EP) 12000680.4

(51) Int. Cl. H02K 3/52

(52) U.S. Cl. CPC H02K 3/522

(57) ABSTRACT

A gearless drive for a rotating electrical machine comprises a rotor in the form of a hollow rotatable body and having an axis of rotation and a stator surrounding the rotor. A plurality of pole bodies are independently mounted circumferentially around the rotor by a pole mounting arrangement. The stiffness of the pole mounting arrangement in the radial direction is greater than the stiffness of the pole mounting arrangement in the circumferential direction.

### TECHNICAL FIELD

The present disclosure relates to a gearless drive for a rotating electrical machine, and more particularly to a gearless mill drive (GMD) for a grinding mill such as an autogenous (AG) mill or a semi-autogenous (SAG) mill.

### TECHNICAL BACKGROUND

Grinding mills are widely used in mineral processing applications and the most common types are the autogenous (AG) grinding mill in which the feed material itself acts as the grinding medium and the semi-autogenous (SAG) grinding mill in which supplementary grinding material, typically steel balls, is added to the feed material.

Many grinding mills employ a gearless mill drive (GMD), also commonly known as a ring motor, in which the mill barrel acts as the rotor and a stator surrounds the rotor. The mill barrel commonly includes a rigid circumferentially extending pole mounting flange and the pole bodies similarly include a rigid circumferentially extending pole support flange. The pole bodies are mounted on the rotor by rigidly bolting together the pole mounting flange and pole support flange.

Grinding mills are often subjected to transient loads in the radial, axial and circumferential directions, particularly during start-up if the material in the mill has settled and formed what is commonly referred to as a ‘frozen charge’. These transient loads have been known to cause fatigue damage to some of the component parts of the rotor assembly of existing gearless mill drives, and torsional shock loads can be particularly problematic.

There is, therefore, a need for an improved gearless drive for a rotating electrical machine, and in particular a gearless mill drive for a grinding mill, which reduces the damage that can arise as a result of transient loads such as torsional shock loads.

### SUMMARY OF THE DISCLOSURE

According to one aspect of the present disclosure, there is provided a gearless drive for a rotating electrical machine, the gearless drive comprising:
a rotor in the form of a hollow rotatable body and having an axis of rotation;
a stator surrounding the rotor;
a plurality of pole bodies independently mounted circumferentially around the rotor;
a pole mounting arrangement for independently mounting each of the pole bodies on the rotor;
wherein the stiffness of the pole mounting arrangement in the radial direction is greater than the stiffness of the pole mounting arrangement in the circumferential direction.

The terms ‘radial’, ‘circumferential’ and ‘axial’ are used herein to refer to directions relative to the axis of rotation of the rotor.

The high stiffness of the pole mounting arrangement in the radial direction minimises any purely radial movement between the pole bodies and the rotor. Air gap control is thus maintained notwithstanding the strong magnetic forces. For example, in embodiments in which the air gap between the rotor and the stator is approximately 6 mm, the stiffness of the pole mounting arrangement in the radial direction may limit purely radial movement of each of the pole bodies with respect to the rotor to a maximum of approximately 0.1 mm.

The lower stiffness of the pole mounting arrangement in the circumferential direction permits a predetermined amount of circumferential movement between each pole body and the rotor. This provides the gearless drive with improved torsional flexibility and damping when compared to existing gearless drives, such as the GMDs described above, in which the pole bodies are rigidly mounted on the rotor. Transient loads, and in particular torsional shock loads, are thus absorbed very effectively by the pole mounting arrangement. For example, in the foregoing embodiment in which purely radial movement of the pole bodies with respect to the rotor is limited to approximately 0.1 mm, circumferential movement of the pole bodies with respect to the rotor may be possible up to approximately 5 mm.

The stiffness of the pole mounting arrangement in the axial direction may be lower than the stiffness of the pole mounting arrangement in the radial direction. Selective independent movement of each of the pole bodies in the axial direction with respect to the rotor may thus be possible and this may facilitate axial alignment of the rotor with respect to the stator, for example during assembly or maintenance of the gearless drive.

The pole mounting arrangement may include a plurality of pole mounting struts which may extend in a substantially radial direction. Each pole body may be independently mounted on the rotor by at least one of said pole mounting struts. Each pole body is normally independently mounted on the rotor by at least two circumferentially spaced pole mounting struts. The use of at least two circumferentially spaced pole mounting struts may improve the stability of the pole bodies and hence the gearless drive.

Each pole mounting strut may include a length adjustment mechanism, for example a turnbuckle. The length adjustment mechanism allows the length of the pole mounting struts to be varied, and this allows the radial position of each pole body with respect to the rotor to be varied independently of the other pole bodies. This advantageously allows adjustment and optimisation of the air gap between the pole bodies and the stator.

Opposite ends of each pole mounting strut are typically secured to the pole body and the rotor by bushes. The stiffness of the bushes may be greater in the radial direction than the circumferential direction. The stiffness of the bushes may be lower in the axial direction than the radial direction. The bushes thus permit the aforesaid relative independent movement between the pole bodies and the rotor in the circumferential direction and possibly also in the axial direction, whilst minimising any purely radial movement.

The pole mounting arrangement may be arranged to permit independent movement of the pole bodies in a radially inward direction, towards the rotor, during circumferential movement of the pole bodies with respect to the rotor. More particularly, each mounting strut may be arranged to permit independent movement of its associated pole body in a radially inward direction, towards the rotor, during circumferential movement of the pole body with respect to the rotor. Each pole body may move independently about an arc whose diameter is less than the diameter of the rotor. As indicated above, any movement in the purely radial direction is minimised. The independent radially inward and circumferential movement of each pole body with respect to the rotor provides a slight increase in the size of the air gap, and hence a reduction in the magnetic forces, in the event that torsional shock loads are encountered. This reduction in the magnetic forces further contributes to the absorption of torsional shock loads, particularly during the start-up phase of the rotating electrical machine.

The pole mounting arrangement may include a plurality of drive links for transmitting torque from the pole bodies to the rotor. At least one of said drive links may extend between each pole body and the rotor. Each drive link may be aligned in a substantially circumferential direction. The substantially circumferential alignment facilitates the transmission of torque from each pole body to the rotor to thereby rotate the rotor. The drive links may be arranged to allow independent movement of the pole bodies in the radial direction with respect to rotor, although as explained above, such radial movement is only possible simultaneously with circumferential movement of the pole bodies with respect to the rotor. The drive links may be arranged to allow independent movement of the pole bodies in the axial direction with respect to rotor. This may facilitate axial alignment of the rotor with respect to the stator, as discussed above.

Opposite ends of each drive link are typically secured to the pole body and the rotor by bushes. The stiffness of the bushes may be greater in the circumferential direction than the radial direction. The stiffness of the bushes may be lower in the axial direction than the circumferential direction. The bushes thus permit the aforesaid relative movement between each of the pole bodies and the rotor in the radial direction and possibly also in the axial direction, whilst minimising any relative movement in the substantially circumferential direction to ensure the effective transmission of torque from the pole bodies to the rotor.

The rotating electrical machine may be a grinding mill in which the hollow rotatable body may be a mill barrel. Accordingly, the gearless drive may be a gearless mill drive (GMD).

The mill barrel may include a pole mounting flange and the pole mounting arrangement may extend between the pole mounting flange and each pole body to thereby provide independent and flexible mounting of the pole bodies on the pole mounting flange of the rotor. More particularly, each mounting link may extend between the pole mounting flange and an associated pole body to thereby independently mount the pole bodies on the pole mounting flange of the rotor. It will, therefore, be understood that the pole mounting arrangement replaces the rigid pole support flange that is employed in existing GMDs such as those described above.

### BRIEF DESCRIPTION OF THE DRAWINGS

FIGS. 1a and 1b are partially cut-away diagrammatic perspective views of a grinding mill including a gearless drive according to the present disclosure;

FIG. 2 is a diagrammatic perspective view of the gearless drive of FIG. 1;

FIG. 3 is an enlarged perspective view of part of the gearless drive of FIG. 2; and

FIG. 4 is a diagrammatic view from one end of the part of the gearless drive shown in FIG. 3.

### DETAILED DESCRIPTION OF EMBODIMENTS

Embodiments will now be described by way of example only and with reference to the accompanying drawings.

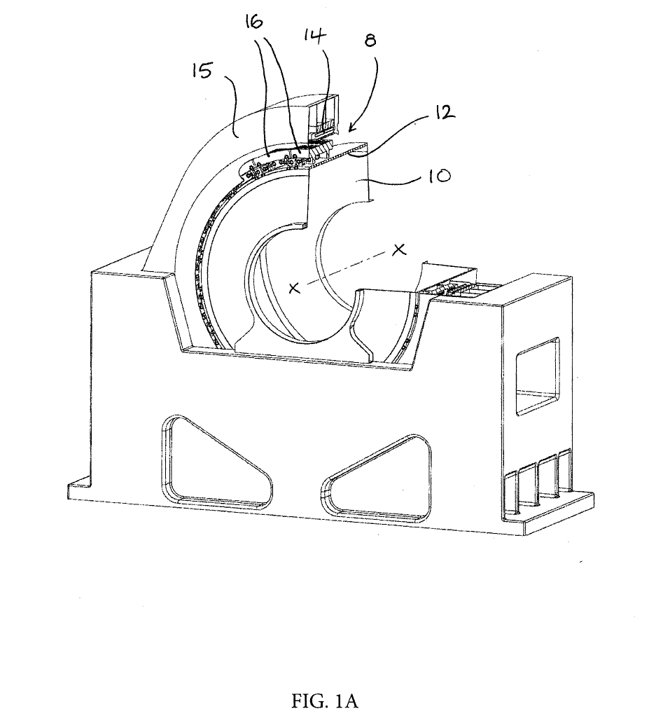

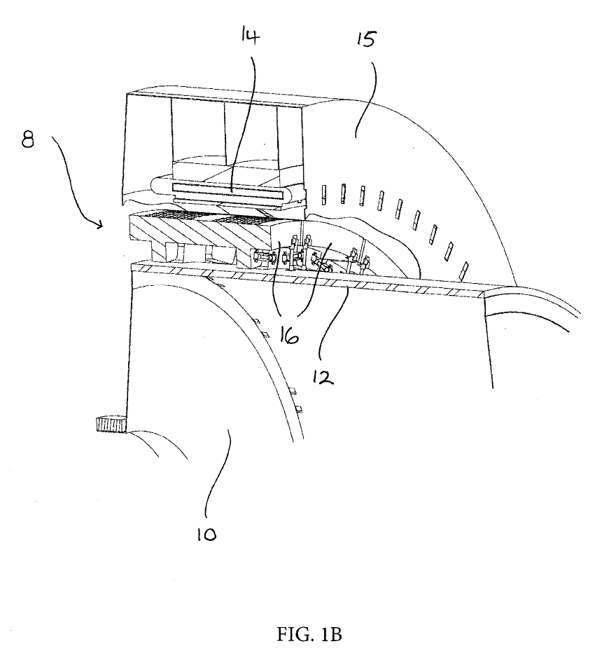

Referring initially to FIGS. 1a and 1b, there is shown a grinding mill which employs a gearless mill drive (GMD) 8 to drive a hollow rotatable mill barrel 10 in which feed material is ground by rotation of the mill barrel 10 about an axis of rotation X-X. The mill barrel acts as the rotor 12 of the gearless mill drive 8 and is surrounded by a stator 14 typically formed by a plurality of stator segments. The stator 14 is fixed to a support frame 15.

A plurality of pole bodies 16 are independently mounted on the rotor 12 at circumferentially spaced positions around the rotor 12. A plurality of permanent magnets are affixed to an upper, and in use radially outer, surface of the pole bodies 16, for example by bonding, by way of mechanical fixings or by any other suitable means. Alternatively, the permanent magnets could be located in a housing which could be secured to the upper, and in use radially outer, surface of the pole bodies 16.

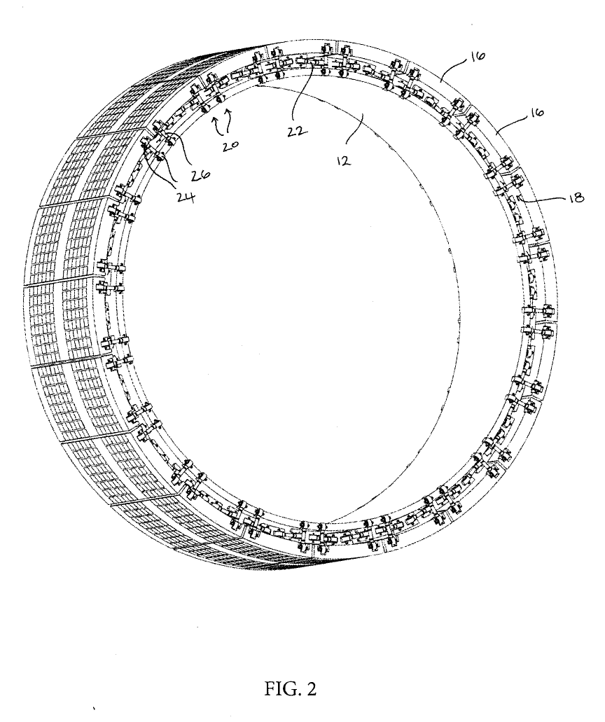

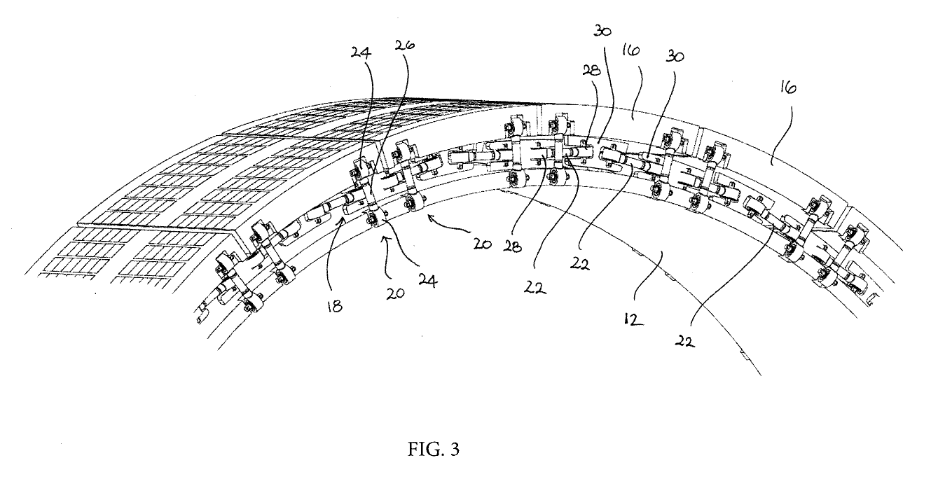

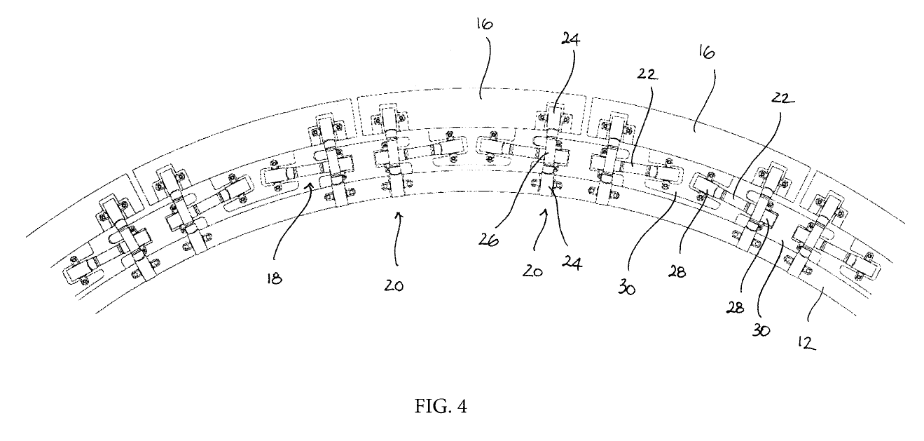

Referring in particular to FIGS. 2 to 4, the pole bodies 16 are mounted independently of each other on the rotor 12 by a pole mounting arrangement 18 comprising a plurality of substantially radially extending pole mounting struts 20 and a plurality of generally circumferentially extending drive links 22.

In the illustrated embodiment, each pole body 16 is independently mounted on the rotor 12 by two axial pairs of circumferentially spaced substantially radially extending pole mounting struts 20, thereby maximising the stability of each pole body 16. Bushes 24 are provided at opposite ends of each pole mounting strut 20 and have a substantially higher stiffness in the radial direction than in either of the circumferential or axial directions. As a consequence, movement of the pole bodies 16 relative to the rotor 12 in the purely radial direction is prevented or at least substantially minimised. On the other hand, some independent limited predetermined movement of the pole bodies 16 relative to the rotor 12 in the generally circumferential direction is permitted and this advantageously provides the gearless mill drive with improved torsional flexibility and damping as already discussed. Likewise, the lower stiffness of the bushes in the axial direction permits some limited independent movement of the pole bodies 16 relative to the rotor 12 in the axial direction. This may facilitate alignment of the pole bodies 16 with the stator 14, especially during assembly or maintenance of the gearless mill drive.

Although movement of the pole bodies 16 relative to the rotor 12 in the purely radial direction is prevented or substantially minimised by the pole mounting struts 20, when one or more of the pole bodies 16 moves independently in the circumferential direction, the one or more pole bodies 16 move independently about an arc of smaller diameter than the diameter of the rotor 12 and, hence, move simultaneously in the radially inward direction away from the stator 14. This increases the size of the air gap between the one or more pole bodies 16 and the stator 14 and thereby reduces the magnetic forces.

Each pole mounting strut 20 includes a length adjustment mechanism in the form of a turnbuckle 26 which enables the length of the strut 20 and, hence, the distance between the bushes 24 to be suitably adjusted. This enables the radial position of the pole bodies 16 to be independently varied and, hence, enables the size of the air gap between the pole bodies 16 and the stator 14 to be optimised.

The generally circumferentially extending drive links 22 are provided to transmit torque from the pole bodies 16 to the rotor 12 and in the illustrated embodiment two drive links 22 couple each pole body 16 to the rotor 12 and are mounted to the pole body 16 and the rotor 12 via suitable bushes 28, which are provided at opposite ends of each drive link 22, and associated support plates 30. The bushes 28 have a relatively high stiffness in the substantially circumferential direction, in line with each drive link 22, to ensure that torque is transmitted effectively from the pole bodies 16 to the rotor 12, although the stiffness is selected such that the overall stiffness of the pole mounting arrangement 18 in the radial direction is greater than the stiffness in the circumferential direction for the reasons discussed above. The stiffness of the bushes 28 is lower in the radial and axial directions than in the circumferential direction so that some limited movement is possible in these directions.

The radially extending pole mounting struts 20 and generally circumferentially extending drive links 22 provide for independent and semi-flexible mounting of each of the pole bodies 16 on the rotor 12 with the result that the gearless mill drive is capable of absorbing transient loads, and especially torsional shock loads, in an effective manner. This is particularly useful in reducing fatigue damage.

Although not illustrated, in some embodiments the mill barrel 10 includes a conventional pole mounting flange in which case the pole mounting struts 20 and drive links 22 extend between the pole mounting flange and each pole body 16 to thereby provide independent and flexible mounting of each of the pole bodies 16 on the pole mounting flange of the rotor 12.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments. Each feature disclosed in the specification, including the claims and drawings, may be replaced by alternative features serving the same, equivalent or similar purposes, unless expressly stated otherwise.

For example, the pole bodies 16 may carry magnetic field coils instead of permanent magnets. Although the description above relates specifically to a gearless mill drive (GMD), the disclosure is equally applicable to gearless drives for other rotating electrical machines that are subject to transient loads, one such example being a wind turbine generator.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

What is claimed is:

1. A gearless drive for a rotating electrical machine, the gearless drive comprising:
a rotor in the form of a hollow rotatable body and having an axis of rotation;
a stator surrounding the rotor;
a plurality of pole bodies mounted circumferentially around the rotor;
a pole mounting arrangement configured to independently mount each of the pole bodies on the rotor;
wherein the stiffness of the pole mounting arrangement in a radial direction is greater than the stiffness of the pole mounting arrangement in a circumferential direction.

2. The gearless drive according to claim 1, wherein the stiffness of the pole mounting arrangement in an axial direction is less than the stiffness of the pole mounting arrangement in the radial direction.

3. The gearless drive according to claim 1, wherein the pole mounting arrangement comprises a plurality of pole mounting struts and each pole body is independently mounted on the rotor by at least one of the pole mounting struts.

4. The gearless drive according to claim 3, wherein each pole mounting strut extends in a substantially radial direction.

5. The gearless drive according to claim 3, wherein opposite ends of each pole mounting strut are secured to the pole body and the rotor by bushes, wherein the stiffness of the bushes in the radial direction is greater than the stiffness of the bushes in the circumferential direction.

6. The gearless drive according to claim 5, wherein the stiffness of the bushes in the axial direction is lower than the stiffness of the bushes in the radial direction.

7. The gearless drive according to claim 3, wherein each pole mounting strut is arranged to permit independent movement of its associated pole body in a radially inward direction, towards the rotor, during circumferential movement of the pole body with respect to the rotor.

8. The gearless drive according to claim 3, wherein each pole mounting strut comprises a length adjustment mechanism.

9. The gearless drive according to claim 1, wherein the pole mounting arrangement comprises a plurality of drive links for transmitting torque from the pole bodies to the rotor, at least one of the drive links extending between each pole body and the rotor.

10. The gearless drive according to claim 9, wherein each drive link is aligned in a substantially circumferential direction.

11. The gearless drive according to claim 1, wherein the rotating electrical machine is a grinding mill in which the hollow rotatable body is a mill barrel.

12. The gearless drive according to claim 2, wherein the pole mounting arrangement comprises a plurality of pole mounting struts and each pole body is independently mounted on the rotor by at least one of the pole mounting struts.

13. The gearless drive according to claim 12, wherein each pole mounting strut extends in a substantially radial direction.

14. The gearless drive according to claim 13, wherein opposite ends of each pole mounting strut are secured to the pole body and the rotor by bushes, wherein the stiffness of the bushes in the radial direction is greater than the stiffness of the bushes in the circumferential direction.

15. The gearless drive according to claim 4, wherein opposite ends of each pole mounting strut are secured to the pole body and the rotor by bushes, wherein the stiffness of the bushes in the radial direction is greater than the stiffness of the bushes in the circumferential direction.

16. The gearless drive according to claim 5, wherein each pole mounting strut is arranged to permit independent movement of its associated pole body in a radially inward direction, towards the rotor, during circumferential movement of the pole body with respect to the rotor.

17. The gearless drive according to claim 16, wherein the pole mounting arrangement comprises a plurality of drive links for transmitting torque from the pole bodies to the rotor, at least one of the drive links extending between each pole body and the rotor.

18. The gearless drive according to claim 3, wherein the pole mounting arrangement comprises a plurality of drive links for transmitting torque from the pole bodies to the rotor, at least one of the drive links extending between each pole body and the rotor.

19. The gearless drive according to claim 5, wherein the pole mounting arrangement comprises a plurality of drive links for transmitting torque from the pole bodies to the rotor, at least one of the drive links extending between each pole body and the rotor.

20. The gearless drive according to claim 7, wherein the pole mounting arrangement comprises a plurality of drive links for transmitting torque from the pole bodies to the rotor, at least one of the drive links extending between each pole body and the rotor.
